(19) United States
(12) Patent Application Publication
(10) Pub. No.: US 2025/0332913 A1
(43) Pub. Date: Oct. 30, 2025

(54) VEHICLE POWER TAKE OFF SYSTEM

(71) Applicant: CF USA LLC, Greer, SC (US)

(72) Inventor: Oliver Fritz, Greer, SC (US)

(73) Assignee: CF USA LLC, Greer, SC (US)

(21) Appl. No.: 19/171,289

(22) Filed: Apr. 6, 2025

Related U.S. Application Data
(60) Provisional application No. 63/639,641, filed on Apr. 28, 2024.

(51) Int. Cl. B60K 17/28; B60K 17/02; B62D 65/10; F16D 3/16; F16H 7/02

(52) U.S. Cl. CPC B60K 17/28; B60K 17/02; B62D 65/10; F16H 7/02; F16D 3/16

(57) ABSTRACT

The present disclosure provides a power take-off system for a vehicle, comprising a power take-off drive shaft configured to be interwoven through a chassis of the vehicle without modifications to the chassis, wherein the take-off drive shaft is disposed under a vehicle body. The system can include a clutch operatively connected to an engine of the vehicle and adapted to selectively engage with the power take-off drive shaft to transfer energy from the engine to the power take-off drive shaft. A power source can be attached to the power take-off drive shaft and adapted to operate with rotational energy provided by the power take-off drive shaft. The power take-off system can be configured to be installed on the vehicle without modifications to existing components or chassis of the vehicle.

### RELATED APPLICATIONS

This application claims priority to U.S. Provisional Application No. 63/639,641 titled VEHICLE POWER TAKE-OFF SYSTEM, filed Apr. 28, 2024, which is hereby incorporated by reference in its entirety.

### FIELD OF INVENTION

The present disclosure relates to power take-off systems for vehicles, and more particularly to a power take-off system designed for integration with commercial vehicles having covered chassis to power external tools and equipment.

### BACKGROUND

Power take-off (PTO) systems are mechanisms that transfer mechanical power from a vehicle's engine to auxiliary equipment. These systems have become integral components in many commercial vehicles, enabling the operation of various tools and machinery without the need for separate power sources. PTO systems find widespread use across industries such as construction, agriculture, utilities, and transportation, where they power hydraulic pumps, winches, compressors, generators, and other specialized equipment.

In commercial road vehicles, PTO systems typically interface with the vehicle's transmission or engine to harness power. This power is then transmitted through a series of shafts, gears, or hydraulic systems to operate external devices. The versatility of PTO systems allows a single vehicle to perform multiple functions, enhancing productivity and reducing the need for dedicated machinery in many applications.

For vehicles with covered chassis, such as delivery vans, utility trucks, and mobile work platforms, PTO systems present unique challenges and opportunities. These vehicles often require power for equipment while maintaining the enclosed structure of the chassis. Examples include refrigeration units in food delivery trucks, hydraulic lifts in utility vehicles, and specialized tools in mobile workshops. In such applications, a PTO system must be compact, efficient, and capable of integration without compromising the vehicle's structural integrity or interior space.

The design of many existing commercial vehicles, particularly those with covered chassis, does not inherently accommodate PTO systems. This creates a demand for PTO solutions that can be retrofitted to a wide range of vehicle models without extensive modifications. Ideally, such systems should be adaptable to various engine and transmission configurations, allowing for installation across different vehicle types and brands.

Furthermore, there is a growing need for PTO systems that can be installed with minimal alterations to the vehicle's original components. This approach helps maintain warranty coverage, simplifies maintenance, and preserves the vehicle's resale value. It also reduces downtime during installation, which is a consideration for businesses relying on their vehicle fleets.

As commercial vehicles continue to evolve, with trends towards electrification and increased computerization, PTO systems must also adapt. There is an emerging requirement for PTO solutions that are compatible with hybrid and electric powertrains, as well as those that can integrate with modern vehicle control systems.

The development of more efficient and versatile PTO systems for commercial vehicles, particularly those with covered chassis, remains an area of ongoing research and innovation in the automotive and equipment manufacturing sectors.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a power take-off system for a vehicle is provided. The power take-off system includes a power take-off drive shaft configured to be interwoven through a chassis of the vehicle without modifications to the chassis wherein the take-off drive shaft is disposed under a vehicle body. The system also includes a clutch operatively connected to an engine of the vehicle and adapted to selectively engage with the power take-off drive shaft to transfer energy from the engine to the power take-off drive shaft. Additionally, the system includes a power source attached to the power take-off drive shaft and adapted to operate with rotational energy provided by the power take-off drive shaft. The power take-off system is configured to be installed on the vehicle without modifications to existing components or chassis of the vehicle.

According to other aspects of the present disclosure, the power take-off system may include one or more of the following features. The power take-off drive shaft may comprise a first drive shaft and a second drive shaft connected by a universal joint. The universal joint may enable the power take-off drive shaft to navigate around existing components of the vehicle. The system may further comprise a gear box operatively associated with the power take-off drive shaft and the power source, wherein the gear box may be configured to modify rotational energy transfer between the power take-off drive shaft and the power source. The gear box may be mounted to the chassis of the vehicle. The system may further comprise a pulley system connected to the engine and a power take-off belt, wherein the power take-off belt may be configured to transfer rotational energy from the engine to the clutch. The pulley system may be integrated with an existing serpentine pulley assembly of the engine.

According to another aspect of the present disclosure, a method of installing a power take-off system on a vehicle is provided. The method includes providing a power take-off drive shaft, interweaving the power take-off drive shaft through a chassis of the vehicle without modifying the chassis, operatively connecting a clutch to an engine of the vehicle, the clutch being adapted to selectively engage with the power take-off drive shaft, and attaching a power source to the power take-off drive shaft, the power source being adapted to operate with rotational energy provided by the power take-off drive shaft. The power take-off system is installed without modifications to existing components or chassis of the vehicle.

According to other aspects of the present disclosure, the method may include one or more of the following features. The method may further comprise connecting the power take-off drive shaft to the power source via a gear box, wherein the gear box may be configured to modify rotational energy transfer between the power take-off drive shaft and the power source. The gear box may be mounted to the chassis of the vehicle without modifying the chassis. The method may further comprise connecting a pulley system to the engine and installing a power take-off belt, wherein the power take-off belt may be configured to transfer rotational energy from the engine to the clutch. The pulley system may be integrated with an existing serpentine pulley assembly of the engine. Providing the power take-off drive shaft may comprise providing a first drive shaft and a second drive shaft, and connecting the first drive shaft to the second drive shaft using a universal joint. Interweaving the power take-off drive shaft through the chassis may comprise routing the first drive shaft and the second drive shaft around existing components of the vehicle using the universal joint.

According to another aspect of the present disclosure, a vehicle power take-off kit is provided. The kit includes a power take-off drive shaft configured to be interwoven through a chassis of a vehicle without modifications to the chassis, a clutch configured to be operatively connected to an engine of the vehicle and adapted to selectively engage with the power take-off drive shaft, a power source configured to be attached to the power take-off drive shaft and adapted to operate with rotational energy provided by the power take-off drive shaft, and mounting hardware for installing the power take-off drive shaft, the clutch, and the power source on the vehicle without modifications to existing components or chassis of the vehicle.

According to other aspects of the present disclosure, the vehicle power take-off kit may include one or more of the following features. The power take-off drive shaft may comprise a first drive shaft and a second drive shaft connected by a universal joint. The universal joint may enable the power take-off drive shaft to navigate around existing components of the vehicle. The kit may further comprise a gear box configured to be operatively associated with the power take-off drive shaft and the power source, wherein the gear box may be configured to modify rotational energy transfer between the power take-off drive shaft and the power source. The gear box may be configured to be mounted to the chassis of the vehicle without modifying the chassis. The kit may further comprise a pulley system configured to be connected to the engine and a power take-off belt, wherein the power take-off belt may be configured to transfer rotational energy from the engine to the clutch.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a side orthogonal view of a vehicle power take-off system, according to aspects of the present disclosure.

FIG. 2 illustrates a side orthogonal view of a power take-off system installed in a vehicle, according to an embodiment.

FIG. 3 illustrates a side view of a power take-off system integrated with a vehicle chassis, according to aspects of the present disclosure.

FIG. 4 illustrates a top view of a power take-off system arranged on a vehicle chassis, according to an embodiment.

FIG. 5 illustrates a perspective view of a power take-off system integrated into a vehicle chassis, according to aspects of the present disclosure.

FIG. 6 illustrates a side view of a power take-off system with an external tool, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present system is a power take-off system comprising an engine, a power take-off drive shaft, a clutch, and a power source. This system is designed to provide auxiliary power for operating tools and equipment in commercial vehicles with covered chassis, such as utility vans and cargo vehicles. Unlike prior art solutions that rely on separate power sources or combustion-driven tools, the disclosed system utilizes the vehicle's existing engine to power various tools and equipment. Notably, the system can be retrofitted to existing chassis, providing flexibility for vehicle operators without requiring extensive modifications to the vehicle structure.

In some cases, the engine may have two operational modes. In a first mode, power may be delivered to the power take-off drive shaft, allowing the system to operate auxiliary equipment. In a second mode, power may be delivered to the power train for vehicle locomotion. This dual-mode capability allows for efficient use of the engine's power output based on the current operational needs.

The power take-off system may allow the engine to idle or run at various speeds while providing power to the power take-off drive shaft. This feature enables the system to operate auxiliary equipment even when the vehicle is stationary, enhancing the versatility and utility of the commercial vehicle. By leveraging the vehicle's existing engine, the system eliminates the need for separate power sources, potentially reducing weight, complexity, and operational costs for users.

In some aspects, the power take-off system may incorporate multiple gear boxes along the drive shaft assembly. These gear boxes may provide for varying power outputs and rotational speeds when the engine is idling. By utilizing different gear ratios, the system may allow for fine-tuning of power delivery to match the specific requirements of different auxiliary equipment. This flexibility in power and speed control may enable the operation of a wide range of tools and machinery, each with potentially unique power needs, while the vehicle's engine remains at a constant idle speed. The ability to adjust power output through multiple gear boxes may also contribute to improved fuel efficiency and reduced wear on the engine, as it allows the engine to operate within its optimal range while still meeting diverse power demands of various auxiliary equipment.

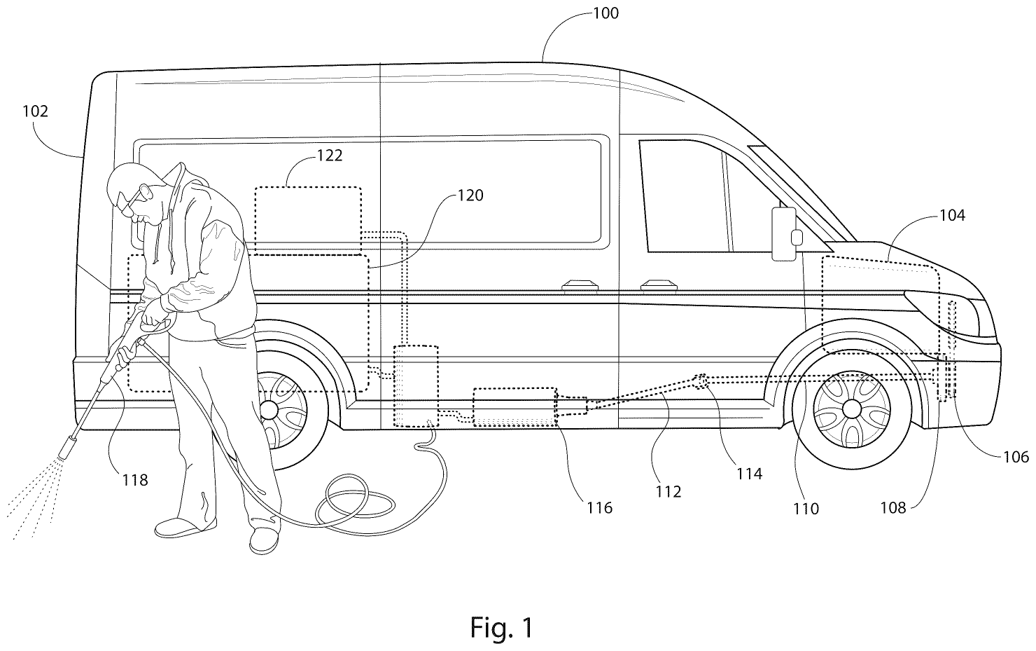

Referring to FIG. 1, a power take-off system is illustrated as integrated with a vehicle 100. The vehicle 100 includes a vehicle body 102 supported by a chassis. A power source 104, such as a fuel engine or electrical motor, is positioned within the vehicle 100 and may provide rotational energy for both vehicle locomotion and auxiliary power functions.

The power take-off system includes a belt system 106 operatively connected to the engine 104. The belt system 106 may transfer rotational energy from the engine 104 to a clutch 108. In some cases, the clutch 108 may selectively engage to transfer power from the engine 104 to the power take-off system components.

A first drive shaft 110 may be connected to the clutch 108 to receive rotational energy when the clutch 108 is engaged. The first drive shaft 110 may be connected to a second drive shaft 112 via a universal joint 114. The use of the universal joint 114 may allow the power take-off drive shaft, comprising the first drive shaft 110 and the second drive shaft 112, to be interwoven through the chassis of the vehicle 100. This configuration may enable the power take-off system to be integrated with existing vehicle structures without requiring significant modifications to the chassis.

The second drive shaft 112 extends to connect with a power source 116. In the illustrated example, the power source 116 may be configured to operate a power washer wand 118. The power washer wand 118 may be used for various cleaning applications, demonstrating one potential use of the auxiliary power provided by the power take-off system.

To support the operation of the power washer wand 118, the vehicle 100 may include a water support 120 and a detergent container 122. These components may store and supply the necessary fluids for the power washing operation, enhancing the utility of the vehicle 100 as a mobile power washing station.

The arrangement of components in FIG. 1 demonstrates how the power take-off system may be integrated within the existing structure of the vehicle 100. The use of multiple drive shafts (110, 112) connected by the universal joint 114 allows for efficient power transfer from the engine 104 to the power source 116, while navigating around existing vehicle components and structures.

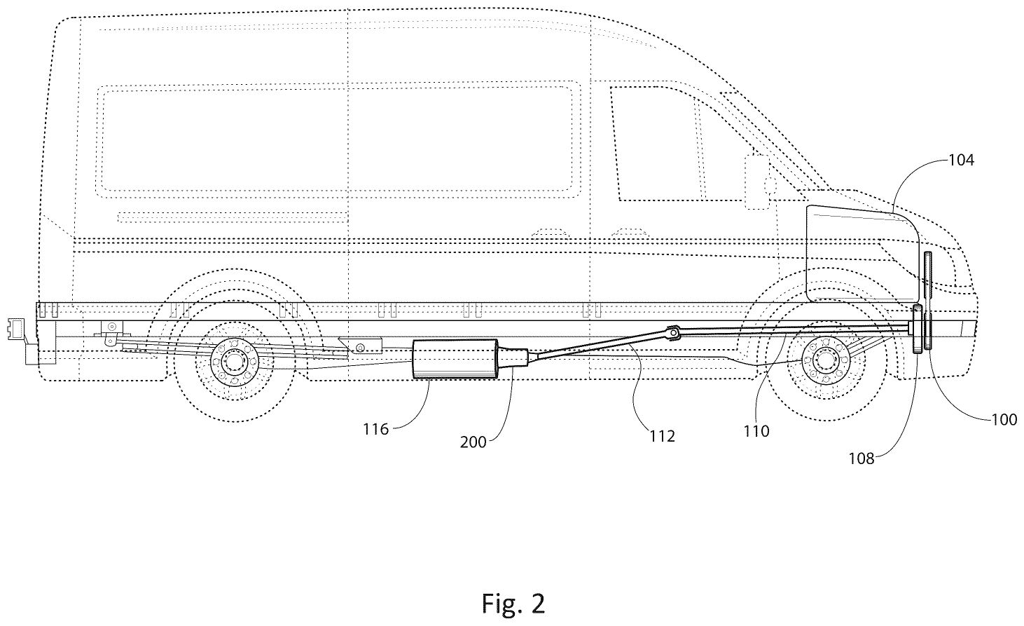

FIG. 2 illustrates a vehicle 100 that can include the engine 104 positioned at the front of the vehicle 100. The clutch 108 may be operatively connected to the engine 104 and may interface with the first drive shaft 110. The first drive shaft 110 may connect to the second drive shaft 112 through a mechanical linkage. In some cases, this mechanical linkage may be the universal joint 114, although the universal joint 114 is not explicitly shown in FIG. 2. The second drive shaft 112 may extend rearward from the first drive shaft 110 to connect with the power source 116. A gear box 200 may be positioned between the second drive shaft 112 and the power source 116. The gear box 200 may be configured to modify the rotational energy transfer between these components. In some cases, the gear box 200 may allow for adjustment of power output to match specific requirements of different auxiliary equipment that may be connected to the power source 116.

The arrangement of these components in FIG. 2 demonstrates how the power take-off system may be integrated within the existing structure of the vehicle 100. The first drive shaft 110 and the second drive shaft 112 may be positioned to efficiently transfer power from the engine 104 to the power source 116 while navigating around existing vehicle components and structures.

In some cases, the compact design of the power take-off system may allow for installation without requiring significant modifications to the vehicle's chassis. This integration approach may preserve the original structural integrity of the vehicle 100 while adding the functionality of the power take-off system. The power take-off system, as shown in FIG. 2, may allow power to be transferred from the engine 104 through the drive shafts to operate the power source 116 when the vehicle 100 is stationary. This configuration may enable the operation of various auxiliary equipment, such as the power washer wand 118 (not shown in FIG. 2), without the need for separate power sources.

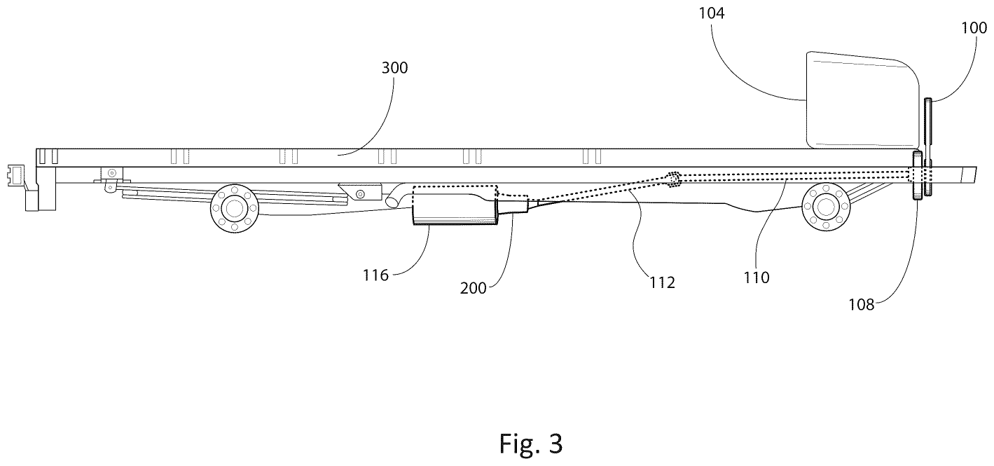

FIG. 3 shows the integration of components with a chassis 300. The chassis 300 may provide the structural framework for the vehicle 100, supporting various components of the power take-off system. The system can include the engine 104 that may provide power through the clutch 108. The first drive shaft 110 may connect to the second drive shaft 112 to transfer rotational energy through the system. The power source 116 may be positioned to receive mechanical energy from the drive shafts. The gear box 200 may be incorporated into the system to modify the rotational energy transfer. In some cases, the power source 116 may be disposed below the vehicle body 102 supported by the chassis 300. This arrangement may allow for efficient use of space within the vehicle 100 while providing convenient access to the power source 116 for maintenance or operation.

The components of the power take-off system may be arranged to be interwoven through the chassis 300. This configuration may allow for installation without requiring structural modifications to the vehicle 100. The first drive shaft 110 and the second drive shaft 112 may be routed around existing chassis components, utilizing the available space efficiently. The gear box 200 may be positioned at a strategic location within the chassis 300 to facilitate the transfer of power from the drive shafts to the power source 116. In some cases, the gear box 200 may be mounted directly to the chassis 300 to provide stability and support.

The arrangement demonstrated in FIG. 3 illustrates how the power take-off system components may be integrated with an existing vehicle chassis while maintaining the structural integrity of the vehicle 100. This integration approach may allow for the addition of auxiliary power capabilities without compromising the original design and functionality of the vehicle 100.

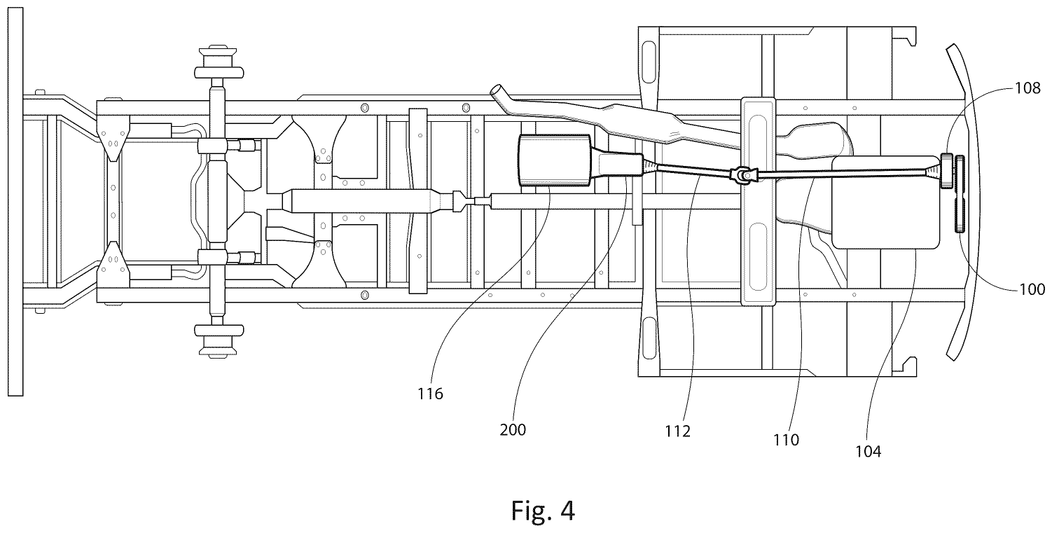

FIG. 4 shows the arrangement of components on the vehicle chassis. The vehicle 100 may include the engine 104 positioned at the front of the chassis. In some cases, the clutch 108 may be connected to the engine 104 and operatively coupled to the first drive shaft 110. The first drive shaft 110 may extend rearward from the clutch 108, following a path along the left side of the chassis. In some cases, the first drive shaft 110 may connect to the second drive shaft 112, which may continue the power transmission path through the chassis. The second drive shaft 112 may extend further rearward, potentially curving slightly to accommodate other vehicle components.

The power source 116 may be positioned along the chassis, typically towards the rear or mid-section of the vehicle 100. In some cases, the power source 116 may be located on the left side of the chassis, in line with the path of the drive shafts. The gear box 200 may be integrated between the second drive shaft 112 and the power source 116. The gear box 200 may be oriented perpendicular to the drive shaft path, allowing for efficient power transfer and potential speed adjustments.

The arrangement of components in the top view may allow for efficient power transmission from the engine 104 through the drive shafts (110, 112) to operate the power source 116 when the vehicle 100 is stationary. The layout may demonstrate how the power take-off system components can be integrated within the existing structure of the vehicle 100, utilizing available space without requiring significant modifications to the chassis.

In some cases, the top view may reveal how the drive shafts (110, 112) are routed around existing vehicle components, such as the transmission or fuel tank. The path of the drive shafts may include subtle curves or bends to navigate these obstacles while maintaining a direct power transmission route from the engine 104 to the power source 116.

The gear box 200 may be strategically positioned to allow for easy access for maintenance or adjustments. In some cases, the gear box 200 may be mounted directly to a structural member of the chassis for stability and proper alignment with the drive shafts.

This arrangement may demonstrate how the power take-off system can be efficiently integrated into the vehicle 100, allowing for the operation of auxiliary equipment through the power source 116 while maintaining the vehicle's original structural integrity and functionality.

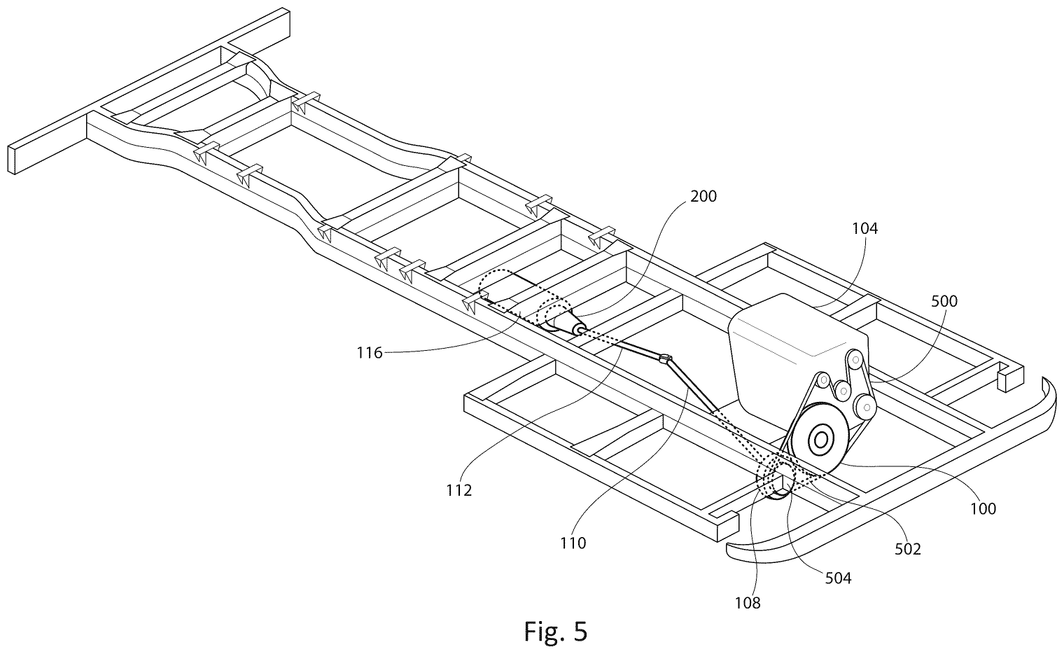

FIG. 5 illustrates a perspective view of the power take-off system integrated into the vehicle chassis. The system shows the engine 104 connected to a pulley system 500 that may transfer rotational energy through a power take-off belt 502. The power take-off belt 502 may connect to a power take-off pulley 504, which may be operatively associated with the clutch 108.

In some cases, the pulley system 500 may be included in a serpentine pulley assembly of the existing engine 104. This configuration may allow for efficient integration of the power take-off system with the vehicle's existing engine components, potentially minimizing the need for extensive modifications to the engine layout.

The system may include the first drive shaft 110 and the second drive shaft 112 arranged to transfer power from the engine 104 through the vehicle chassis. The power source 116 may be positioned to receive rotational energy from the drive shaft arrangement. The gear box 200 may be incorporated into the system to modify the rotational energy transfer between components.

The arrangement shown in FIG. 5 demonstrates how the power take-off system components may be integrated within the vehicle 100, with the drive shafts positioned to efficiently transfer power while maintaining the structural integrity of the chassis. The power take-off pulley 504 and the clutch 108 assembly may allow for selective engagement of the power transfer system when needed.

In some cases, the power take-off belt 502 may be a separate belt from the vehicle's main serpentine belt, allowing for independent operation of the power take-off system. The power take-off pulley 504 may be designed to match the specifications of the power take-off belt 502, ensuring optimal power transfer from the engine 104 to the drive shaft system.

The integration of the pulley system 500 with the existing engine components may demonstrate the adaptability of the power take-off system to various vehicle configurations. This design approach may allow for retrofitting the system to existing vehicles without requiring significant modifications to the engine compartment or chassis structure.

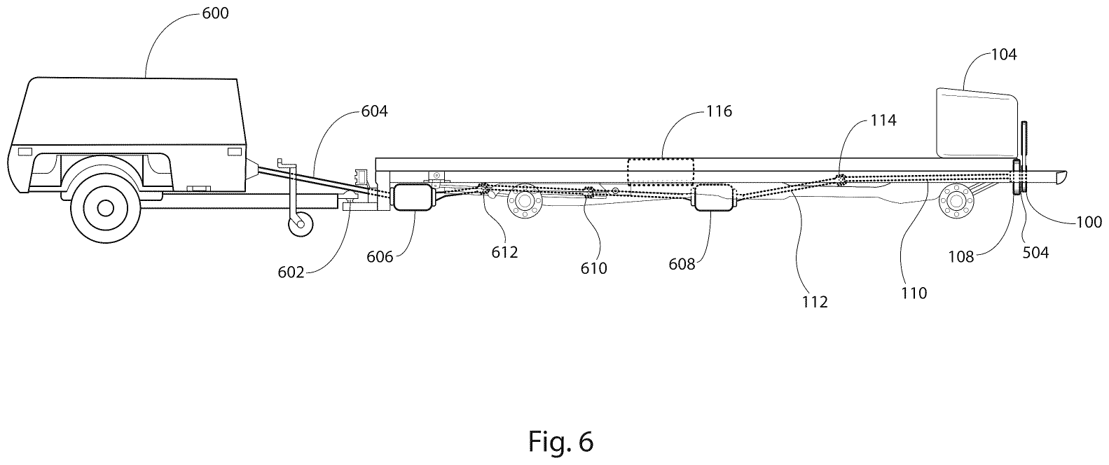

FIG. 6 illustrates a power take-off system showing the integration of an external tool with a vehicle power system. The vehicle 100 includes the engine 104 that connects to a power transfer system. The clutch 108 may be connected to the power take-off pulley 504, which may transfer rotational energy through a series of drive shafts.

The system includes the first drive shaft 110 and the second drive shaft 112 connected by the universal joint 114. The power source 116 may be connected to receive rotational energy through this drive shaft arrangement. In some cases, the system extends rearward with a rear drive shaft 604 that may connect to an external tool 600.

The external tool 600 may be removably attached to the vehicle 100 via a trailer hitch 602. In some cases, the external tool 600 may be supported by a trailer. The rear drive shaft 604 may be adapted to provide rotational energy to the external tool 600, allowing for power transfer from the vehicle's engine 104 to equipment located outside the vehicle body 102.

The power transfer system incorporates multiple gear boxes, including a first gear box 608 and a second gear box 606, which may allow for different rotational energy requirements. In some cases, the first gear box 608 may be operatively associated with the power source 116, while the second gear box 606 may be operatively associated with the external tool 600. This configuration may enable the system to provide appropriate power outputs for both internal and external equipment.

The drive shafts may be connected through additional universal joints, including a second universal joint 610 and a third universal joint 612. These universal joints may enable the drive shafts to navigate around the vehicle's chassis components, allowing for efficient power transfer while accommodating the vehicle's structural layout.

This configuration may allow power to be transferred from the engine 104 through the various drive shafts and gear boxes to both the power source 116 and the external tool 600, providing mechanical power at multiple locations on the vehicle 100. The arrangement demonstrates the versatility of the power take-off system, enabling the operation of both internal equipment and external tools using the vehicle's engine as the primary power source.

The power take-off system may operate by transferring power from the vehicle's engine through a series of components to auxiliary equipment. In some cases, when the power take-off system is engaged, a clutch may connect the engine's rotational energy to a power take-off drive shaft. This engagement may allow power to be directed away from the vehicle's locomotion drive shaft and towards the auxiliary equipment. The system may include multiple drive shafts connected by universal joints, which may allow for power transmission around existing vehicle components. In some cases, gear boxes may be incorporated along the power transmission path. These gear boxes may modify the rotational energy, potentially adjusting speed or torque to meet the specific requirements of different auxiliary equipment.

A component in the operation of the power take-off system may be the clutch. The clutch may allow for selective engagement of the power take-off system. When engaged, the clutch may transfer power from the engine to the power take-off drive shaft. When disengaged, the engine's power may be directed solely to the vehicle's locomotion systems. In some cases, the power take-off system may have two operational modes. In a first mode, power may be delivered to the power take-off drive shaft for operating auxiliary equipment. In a second mode, power may be directed to the vehicle's power train for locomotion. This dual-mode capability may allow for efficient use of the engine's power output based on current operational needs.

The system may allow for operation of auxiliary equipment when the vehicle is stationary. In some cases, an engine controller may be adapted to increase the engine's idle speed when the power take-off system is in the operating position. This increased idle speed may provide additional power for operating auxiliary equipment without the need for separate power sources. The power take-off system may also include provisions for powering external equipment. In some cases, a rear drive shaft may extend past the rear of the vehicle, allowing for connection to external tools or equipment. This configuration may enable the vehicle to serve as a mobile power source for a wide range of applications.

Through this arrangement of components and operational modes, the power take-off system may provide a versatile solution for powering various tools and equipment using the vehicle's existing engine, potentially eliminating the need for separate power sources and enhancing the utility of commercial vehicles.

The power take-off system may be adapted to accommodate various configurations and applications, providing flexibility for different commercial vehicle types and auxiliary equipment needs. In some cases, the arrangement of drive shafts may be modified to suit specific vehicle layouts. For example, the system may incorporate additional universal joints or curved drive shaft sections to navigate around unique chassis components or accommodate different engine placements.

In some cases, the power take-off system may include additional gear boxes along the power transmission path. These additional gear boxes may allow for more precise control of power output and rotational speed, potentially enabling the system to power a wider range of auxiliary equipment with varying power requirements.

The power take-off system may be integrated with various types of commercial vehicles beyond utility vans. In some cases, the system may be adapted for use in larger trucks, specialized service vehicles, or even agricultural equipment. The adaptability of the system may allow for retrofitting existing vehicles across different industries, potentially expanding the utility of various commercial vehicle fleets.

In some cases, the power take-off system may be adapted for use in various types of vehicles beyond utility vans. The system may be integrated into commercial trucks, where it may be used to operate hydraulic lifts for loading and unloading cargo, or to power refrigeration units in temperature-controlled transport vehicles.

For agricultural tractors, the power take-off system may be configured to drive implements such as balers, mowers, or seed drills. This configuration may allow farmers to utilize a single power source for multiple field operations, potentially increasing efficiency and reducing equipment costs.

In construction equipment, the power take-off system may be adapted to operate specialized attachments such as concrete mixers, augers, or compactors. The system may allow construction vehicles to serve multiple functions on job sites, potentially reducing the need for separate dedicated machines.

Emergency vehicles, such as fire trucks or rescue vehicles, may utilize the power take-off system to operate water pumps, aerial lifts, or rescue equipment. This application may enable emergency responders to access a reliable power source for critical operations directly from the vehicle's engine.

Utility vehicles, including those used by telecommunications or energy companies, may incorporate the power take-off system to power boom lifts, cable-laying equipment, or mobile generators. This configuration may allow utility crews to perform a wide range of tasks using a single vehicle platform.

The power take-off system may also be adapted for use in specialized service vehicles, such as mobile workshops or maintenance trucks. In these applications, the system may power air compressors, welding equipment, or other tools required for on-site repairs and maintenance.

In some cases, the power take-off system may be integrated into recreational vehicles or mobile homes, where it may be used to operate stabilizing jacks, slide-out mechanisms, or onboard generators. This application may enhance the self-sufficiency of these vehicles in various environments.

The adaptability of the power take-off system may allow for its integration into a wide range of vehicle types and configurations beyond those specifically mentioned. The system's design may be modified to suit the particular power requirements and space constraints of different vehicle platforms, potentially expanding its utility across diverse industries and applications.

In some cases, the power source of the power take-off system may be adapted to power a diverse range of tools and equipment. For example, the system may be configured to operate a combustion driver nail gun, providing a mobile power source for construction applications. In other cases, the power source may be adapted to drive a jack hammer, enabling road repair or demolition work without the need for separate power units.

The versatility of the power take-off system may extend to powering paint sprayers, potentially facilitating mobile painting operations for large-scale projects or vehicle refinishing. In some cases, the system may be designed to accommodate quick-connect interfaces, allowing for rapid switching between different types of power tools or equipment.

Beyond these specific examples, the power take-off system may be engineered to power a wide array of other power tools. This adaptability may enable the system to serve diverse industries and applications, potentially including but not limited to landscaping equipment, welding machines, or mobile compressors for pneumatic tools.

In some cases, the power take-off system may incorporate modular components, allowing for easy customization or upgrades to meet evolving equipment needs. This modular approach may enable vehicle operators to adapt their power take-off capabilities over time without requiring a complete system overhaul.

The control mechanisms for the power take-off system may also vary. In some cases, the system may include electronic controls integrated with the vehicle's existing computer systems, allowing for precise management of power output and engagement. In other cases, mechanical control systems may be employed for simplicity and durability in harsh operating environments.

In some variations, the power take-off system may be designed to operate multiple pieces of equipment simultaneously. This configuration may involve multiple power output points or a power distribution system, potentially increasing the versatility and efficiency of mobile operations.

The integration of the power take-off system with the vehicle's existing systems may also vary. In some cases, the system may be designed to interface with the vehicle's onboard diagnostics, potentially allowing for monitoring of power usage, system health, and maintenance scheduling through existing vehicle interfaces.

These variations and alternative embodiments demonstrate the potential adaptability and scalability of the power take-off system, potentially enabling its application across a wide range of commercial vehicles and auxiliary equipment needs.

A number of implementations have been described. Nevertheless, it will be understood that various modifications may be made without departing from the spirit and scope of the disclosure. Accordingly, other implementations are within the scope of the following claims.

What is claimed is:

1. A power take-off system for a vehicle, comprising:
a power take-off assembly having a power take-off drive shaft configured to be interwoven through a chassis of a vehicle wherein the power take-off drive shaft is disposed under a vehicle body;
a clutch operatively connected to an engine of the vehicle and adapted to selectively engage with the power take-off drive shaft to transfer energy from the engine to the power take-off drive shaft; and,
wherein the power take-off system is configured to be installed on the vehicle without modifications to existing chassis of the vehicle.

2. The power take-off system of claim 1, wherein the power take-off drive shaft includes a first drive shaft and a second drive shaft connected by a universal joint.

3. The power take-off system of claim 2, wherein the universal joint enables the power take-off drive shaft to navigate around existing components of the vehicle.

4. The power take-off system of claim 1, including a gear box operatively associated with the power take-off drive shaft, wherein the gear box is configured to modify rotational energy transfer between the power take-off drive shaft and the engine.

5. The power take-off system of claim 4, wherein the gear box is mounted to the chassis of the vehicle.

6. The power take-off system of claim 1, including a pulley system connected to the engine and a power take-off belt, wherein the power take-off belt is configured to transfer rotational energy from the engine to the clutch.

7. The power take-off system of claim 6, wherein the pulley system is integrated with an existing pulley assembly carried by the engine.

8. A method of installing a power take-off system on a vehicle, comprising:
providing a power take-off drive shaft;
interweaving the power take-off drive shaft through a chassis of the vehicle without modifying the chassis;
operatively connecting a clutch to an engine of the vehicle, the clutch being adapted to selectively engage with the power take-off drive shaft;
wherein the power take-off system is installed without modifications to existing components or chassis of the vehicle.

9. The method of claim 8, including connecting the power take-off drive shaft to the engine via a gear box, wherein the gear box is configured to modify rotational energy transfer between the power take-off drive shaft and the engine.

10. The method of claim 9, including mouthing the gear box is mounted to the chassis of the vehicle without modifying the chassis.

11. The method of claim 8, including connecting a power take-off pulley system to the engine and installing a power take-off belt, wherein the power take-off belt is configured to transfer rotational energy from the engine to the clutch.

12. The method of claim 11, wherein the power take-off pulley system is integrated with an existing pulley assembly of the engine.

13. The method of claim 8, wherein providing the power take-off drive shaft comprises providing a first drive shaft and a second drive shaft, and connecting the first drive shaft to the second drive shaft using a universal joint.

14. The method of claim 13, wherein interweaving the power take-off drive shaft through the chassis comprises routing the first drive shaft and the second drive shaft around existing components of the vehicle.

15. A vehicle power take-off system, comprising:
a power take-off drive shaft configured to be interwoven through a chassis of a vehicle without modifications to the chassis;
a clutch configured to be operatively connected to a power source of the vehicle and adapted to selectively engage with the power take-off drive shaft; and,
mounting hardware for installing the power take-off drive shaft, the clutch, and the power source on the vehicle without modifications to existing components or chassis of the vehicle.

16. The vehicle power take-off system of claim 15, wherein the power take-off drive shaft comprises a first drive shaft and a second drive shaft connected by a universal joint.

17. The vehicle power take-off system of claim 16, wherein the universal joint is configured to enable the power take-off drive shaft to navigate around existing components of the vehicle.

18. The vehicle power take-off system of claim 15, including:
a gear box configured to be operatively associated with the power take-off drive shaft and the power source, and;
wherein the gear box is configured to modify rotational energy transfer between the power take-off drive shaft and the power source.

19. The vehicle power take-off system of claim 18, wherein the gear box is configured to be mounted to the chassis of the vehicle without modifying the chassis.

20. The vehicle power take-off system of claim 15, including a pulley system configured to be connected to the power source and a power take-off belt, wherein the power take-off belt is configured to transfer rotational energy from the power source to the clutch.
